(19) United States
(12) Patent Application Publication
(10) Pub. No.: US 2022/0158976 A1
(43) Pub. Date: May 19, 2022

(54) Method And Apparatus For Remote Network Management

(71) Applicant: Morbit Software Ltd., Norwich (GB)

(72) Inventors: Timothy Kefford, Norwich (GB); Robert Thornley, Norwich (GB)

(21) Appl. No.: 17/433,529

(22) PCT Filed: Feb. 26, 2020
(86) PCT No.: PCT/EP2020/055072

§ 371 Date: Aug. 24, 2021

(30) Foreign Application Priority Data
Feb. 27, 2019 (GB) 1902637.6

(51) Int. Cl. H04L 9/40; H04L 41/0806

(52) U.S. Cl. CPC H04L 63/0227; H04L 41/0806

(57) ABSTRACT

A hub device for remote network management includes a communication interface and a processor. The communication interface is arranged to communicate with a local network. The communication interface is also arranged to communicate with a remote server over a secure internet connection. The processor is arranged to receive discovery instructions from the remote server; interrogate local devices connected to the local network; filter the interrogation results in accordance with the discovery instructions; and send the filtered results to the remote server.

### TECHNICAL FIELD

The present application relates to a hub device, a method for remote network management, a computer-readable medium, and an apparatus for remote network management.

### BACKGROUND

A local network allows a plurality of computing devices to communicate with each other. Examples of computing devices include desktop personal computers (PC's), laptops, smart phones, tablets, printers, routers, network switches, servers, modems, and wireless access points. Network connections may be wired or wireless.

Certain computing devices enable configuration from another computing device within the same network. A common example is a router that displays a configuration webpage to a network connected PC allowing the user of that PC to change settings on the router. Network connected printers may be configured in a similar way. However, the configuration webpage is only available to devices within the local network.

It is possible to set up an individual computing device to be configured from a remote connection over the Internet, but such an arrangement typically requires firewall traversal. This is sufficiently complicated so as not to be scalable for large networks comprising a plurality of configurable computing devices. Further, firewall traversal can present a security risk.

Remote network management is attractive because it allows a skilled engineer to manage a plurality of geographically disparate networks without spending time travelling between them. Remote network management is thus a cost-effective form of network management. However, local networks are often critical to the work of the users that use them, and such networks may also handle sensitive data, which must be carefully protected to avoid legal and/or commercial consequences.

A concern with remote network management is that of compromised security. If an external engineer is able to login and configure the network, then an external malicious user may be able to compromise the network. There is thus a need for a system that provides the cost savings and benefits of remote network management without excessive complexity, and yet still provides the network users with secure control over their network and the data within it.

### BRIEF SUMMARY

There is provided a hub device for remote network management, the hub device comprising a communication interface and a processor. The communication interface is arranged to communicate with a local network, and the communication interface is also arranged to communicate with a remote server over a secure internet connection. The processor is arranged to receive discovery instructions from the remote server, interrogate local devices connected to the local network, filter the interrogation results in accordance with the discovery instructions, and send the filtered results to the remote server.

The filtering is performed within the local network such that only information defined by the discovery instructions leaves the local network. A user of the system may define the discovery instructions thus allowing that user to define what information about the local network leaves the local network. This makes it possible for the hub device to be used for a specific purpose, such as managing printing devices, without the need to give remote access to other sensitive devices on the local network, such as local servers.

The processor may be further arranged to receive a configuration command from the remote server, the configuration command for a local device connected to the local network, and perform a configuration operation on the local device.

The hub device can identify devices on the local network according to the discovery instructions. Once the devices are identified, the hub device can deliver configuration commands to a device on the local network. The configuration command may be delivered via a telnet interface or a browser interface. The hub device may remotely configure a device using any programmable protocol with an API, such as HTTP POST commands, or it may issue a command line command on a remote console via SSH or Telnet.

The secure internet connection may use the HTTPS protocol.

The interrogation may use network fingerprinting. The interrogation may use at least one of local network address range, Address Resolution Protocol (ARP), reverse DNS queries, Organizationally Unique Identifier (OUI) Lookup, Port scan, or detection of NetBIOS, WMI, and SNMP.

The discovery instructions may define a type of device that is to be reported to the remote server.

The hub device may comprise a local device connected to the local network that is adapted to operate as a hub device. The adaptation may comprise installing a software application on the local device. The local device may be a personal computer, a server, or some other multi-function computing device. The hub device may be built into a local device such as a network connected printer. The hub device functionality may be installed on an existing local device such as a network connected printer by way of a firmware upgrade.

The hub device may be a dedicated device connected to the local network. The dedicated device may be a Raspberry Pi® or similar inexpensive computing device.

There is further provided a method for remote network management, the method performed by a device arranged to communicate with a local network and to communicate with a remote server over a secure internet connection. The method comprises receiving discovery instructions from the remote server, interrogating local devices connected to the local network, filtering the interrogation results in accordance with the discovery instructions, and sending the filtered results to the remote server.

The device could be an existing local device upon which hub software is installed to perform the above defined method. The device could be a dedicated hub device connected to the local network and to perform the above defined method.

The method may further comprise receiving a configuration command from the remote server, the configuration command for a local device connected to the local network, and performing a configuration operation on the local device.

There is further provided a computer-readable medium carrying instructions that, when executed by a processor of a local device connected to a local network via a communication interface, causes said processor to receive discovery instructions from a remote server via the communication interface of the local device, interrogate local devices connected to the local network, filter the interrogation results in accordance with the discovery instructions, and send the filtered results to the remote server.

The computer-readable medium may carry further instructions for causing said processor to receive a configuration command from the remote server, the configuration command for a local device connected to the local network, and perform a configuration operation on the local device.

There is further provided an apparatus for remote network management comprising a processor and a memory. Said memory contains instructions executable by said processor whereby said apparatus is operative to receive discovery instructions from a remote server, interrogate local devices connected to a local network, filter the interrogation results in accordance with the discovery instructions, and send the filtered results to the remote server.

There is further provided an apparatus for remote network management comprising a processor and a memory. Said memory contains instructions executable by said processor whereby said apparatus comprises means for receiving discovery instructions from a remote server, means for interrogating local devices connected to a local network, means for filtering the interrogation results in accordance with the discovery instructions, and means for sending the filtered results to the remote server.

There is further provided a computer-readable medium carrying instructions that, when executed by computer logic, causes said computer logic to carry out any of the methods defined herein.

There is further provided a computer-readable storage medium storing instructions that, when executed by computer logic, causes said computer logic to carry out any of the methods defined herein. The computer program product may be in the form of a non-volatile memory or volatile memory, e.g., an EEPROM (Electrically Erasable Programmable Read-only Memory), a flash memory, a disk drive, or a RAM (Random-access memory).

There is further provided an application for remote network management, the application arranged to be run on a device comprising a communication interface for communicating with a local network and for communicating with a remote server over a secure internet connection. The application is arranged to receive discovery instructions from a remote server via the communication interface of the local device, interrogate local devices connected to the local network, filter the interrogation results in accordance with the discovery instructions, and send the filtered results to the remote server.

There is further provided a computer-readable medium carrying instructions that, when executed by computer logic, causes said computer logic to carry out any of the methods defined herein.

### BRIEF DESCRIPTION OF THE DRAWINGS

A method and apparatus for remote network management will now be described, by way of example only, with reference to the accompanying drawings.

FIG. 1 illustrates a local network.

FIG. 2 illustrates a hardware hub.

FIG. 3 illustrates a software hub.

FIG. 4 is a signaling diagram showing the set-up of a hub.

FIG. 5 is a signaling diagram showing a device configuration.

FIG. 6 illustrates a local network interrogation process.

FIG. 7 illustrates a hub device.

FIG. 8 illustrates a method for remote network management.

### DETAILED DESCRIPTION

A local network may be defined by a subnet mask. A subnet mask is a number that defines a range of IP addresses that can be used in the local network. Subnet masks are used to designate subnetworks, or subnets, which are typically local networks. The local network is connected to the internet via an internet gateway. Devices within the same subnet can communicate directly with each other.

The subnet mask hides, or “masks,” the network part of a system's IP address and leaves only the host part as the machine identifier. A common subnet mask is “255.255.255.0”. Each section of the subnet mask can contain a number from 0 to 255, just like an IP address. In “255.255.255.0” the first three sections are full, meaning the IP addresses of computers within the subnet mask must be identical in the first three sections. The last section of each computer's IP address can be anything from 0 to 255. For example, the IP addresses 192.168.1.201 and 192.168.1.202 would be in the same subnet, while 57.168.1.201 would not. A subnet mask of 255.255.255.0 allows for almost 256 unique devices or hosts within the network (some of the 256 IP addresses are reserved and cannot be used for device addresses).

Devices within a local network typically communicate using at least one network protocol. For example, Ethernet (IEEE 802.3) is a family of computer networking technologies commonly used in local networks. Wi-Fi® is technology for radio wireless local networking of devices based on the IEEE 802.11 standards. The Wi-Fi® protocols (IEEE 802.11a/b/g/n/ac) are in the IEEE 802 protocol family that includes Ethernet, which Wi-Fi® is designed to interwork with. The Internet protocols are typically layered on the IEEE 802 protocols, which in turn have some specific provisions for Wi-Fi®.

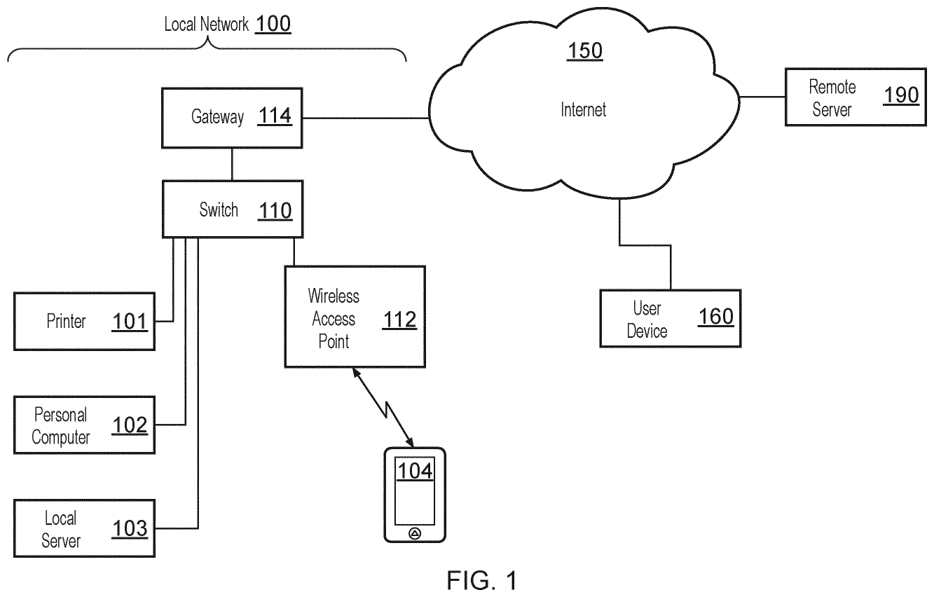

FIG. 1 illustrates a local network 100. A plurality of devices are connected to each other within the local network 100. In this example, the connected devices are a printer 101, a personal computer 102, a local server 103, and a mobile phone 104. The printer 101, the personal computer 102, and the local sever 103 are connected to a network switch 110 that allows network traffic to be communicated between the devices. A wireless access point 112 is also connected to the network switch 110, the wireless access point 112 provides a connection for the mobile phone 104 to connect to the local network 100 using a wireless communication protocol such as Wi-Fi®. Devices connected to the local network 100 can communicate data between each other using a networking protocol. An internet gateway 114 provides a connection between the local network 100 and the internet 150. Internet gateway 114 allows devices within the local network 100 to access the internet 150. A remote server 190 and a user device 160 are also connected to the internet 150. Each may have a connection to the internet provided by additional network equipment not shown. For example, user device 160 may be a cellular communication device that connects via radio to a cellular communication network, which in turn connects to the internet 150 by a respective internet gateway.

Internet gateway 114 is a device used in communications networks that allows data to flow from one discrete network to another. In FIG. 1, internet gateway 114 allows data to be communicated between the internet 150 and the local network 100. Typically, internet gateway 114 is connected to the internet via a modem. The modem may provide an internet connection via ADSL over copper telephone line, a co-axial cable connection, an optical-fibre connection, or a cellular telecommunications network. An internet gateway 114 may use more than one modem for redundancy.

Internet gateway 114 may include a firewall function. A firewall is a network security system that monitors and controls incoming and outgoing network traffic based on predetermined security rules. For example, a firewall may prevent certain ports being used for communication between the local network and remote server

Internet gateway 114 performs Network Address Translation (NAT), which is a method of remapping one IP address space into another by modifying network address information in the IP header of packets while they are in transit across the internet gateway 114. The technique was originally used as a shortcut to avoid the need to readdress every host when a network was moved. It has become a popular and essential tool in conserving global address space in the face of IPv4 address exhaustion. One Internet-routable IP address of the internet gateway 114 can be used for an entire local network, which may then be considered as a private network.

However, Network Address Translation makes it difficult for a remote server 190 to initiate a communication with a device in the local network 100, say printer 101. Further, certain network tools and configuration interfaces are only available to devices within the same subnet and so cannot be accessed by a remote server 190.

The present application provides a solution to this problem while preserving the security of the local network 100. Further, the solution provided herein allows a network manager to control the information that leaves the local network 100.

The solution provided herein comprises a module installed in the local network 100. The module is presented here in two embodiments, a software hub and a hardware hub. The software hub may be installed on a computing device such as personal computer 102 connected to the local network 100. The hardware hub comprises a dedicated computing device connected to the local network 100 and running hub software. The hardware hub may comprise a Raspberry Pi® running Windows® 10 IoT Core, and be connected to the network switch 110 of the local network 100 via a wired internet connection.

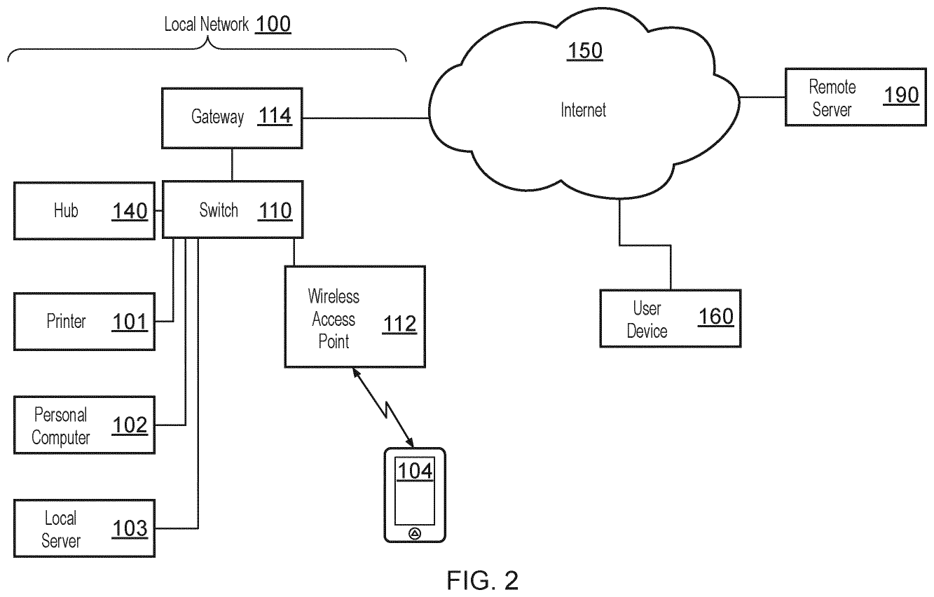

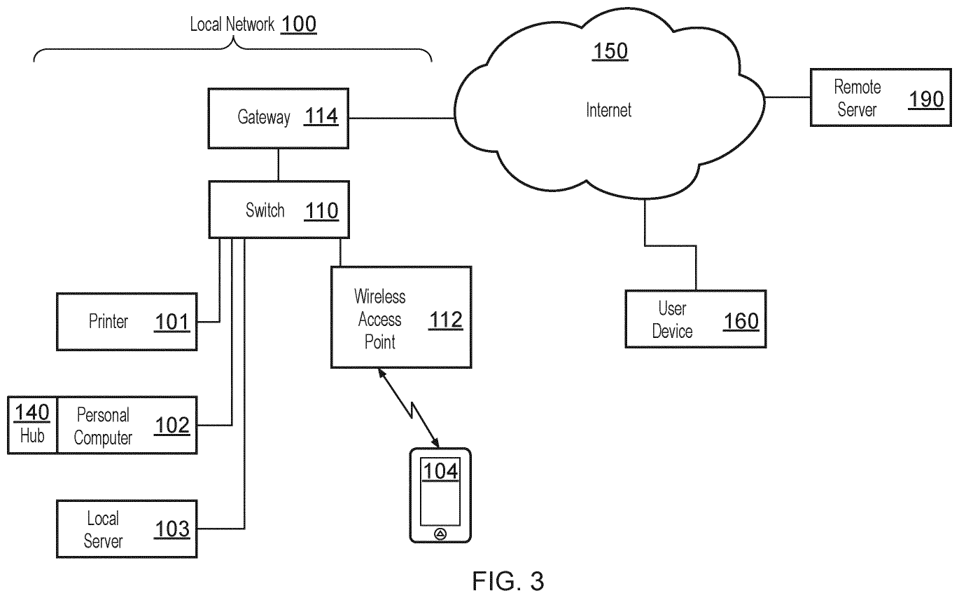

FIG. 2 illustrates a hardware hub 140 connected to a network switch 110 of the local network 100. FIG. 3 illustrates a software hub 140 installed on a personal computer 102 of the local network 100.

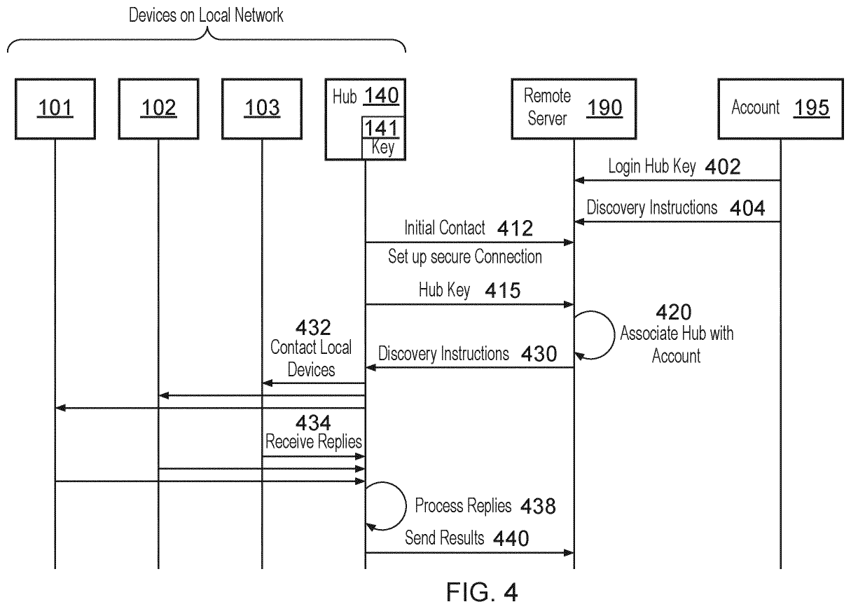

FIG. 4 is a signaling diagram showing the set-up of a hub 140. A user, typically the network manager, sets up a user account 195 on a service platform provided by remote server 190. The network manager installs a hub 140 in the local network 100. As part of that installation, the user acquires an encryption key for the hub, which is a hub key 141. Hub key 141 may be included on a card with a hardware hub, or may be shown on a screen of a computing device on which a software hub is installed. The hub key 141 is a unique 36-character alphanumeric key. The network manager logs in 402 to the platform provided by remote sever 190 and inputs the hub key 141 to the remote server 190 and associates it with the account 195. The network manager then sets discovery instructions 404 to define what information the hub 140 can send from the local network to the remote server 190.

After installation, the hub 140 periodically contacts 412 remote server 190 and establishes a secure connection. The hub 140 sends 415 its hub key 141 to the remote sever. The secure connection is established from the local network 100 and through an internet gateway, not shown in FIG. 4. The hub 140 identifies itself to the remote server 190 using the hub key 141. The hub key 141 received 415 from the hub 140 matches the hub key 141 input 402 via the user account 195, and the remote server associates 420 the hub 140 with the account 195. The hub 140 is thus paired with the user account 195.

Remote server 190 sends 430 discovery instructions to the hub 140. The discovery instructions sent 430 from the remote server 190 to the hub 140 are set by the discovery instructions input 404 from the account 195 to the remote server 190.

Upon receipt 430 of discovery instructions, hub 140 begins interrogating 432 the devices of the local network 100. The interrogation process will be described further below. The hub 140 receives 434 replies from the devices of the local network 100. The hub 140 processes 438 the replies received to identify only information defined by the discovery instructions. Any non-relevant information is filtered out. The hub 140 then sends 440 the results to the remote server 190. Remote server 190 may display the results to the network manager via account 195. Only information about devices defined according to the discovery instructions is sent out of the local network to the remote server 190.

The hub 140 can additionally be used to deliver device configuration instructions to a device 102 on the local network 100. Device configuration interfaces are typically only available to devices within the local network, and as such a remote server cannot typically access such device configuration interfaces. Examples of such local device configuration interfaces are also known as Application Programming Interfaces (API). The hub 140 communicates over IP to the relevant protocol for an API of a device on a network. These may be SSH or locally served web pages, for example a router configuration page displayed in a browser of a locally connected device. Configuration instructions can only be sent to local devices that have been identified to the remote server 195 in accordance with the discovery instructions.

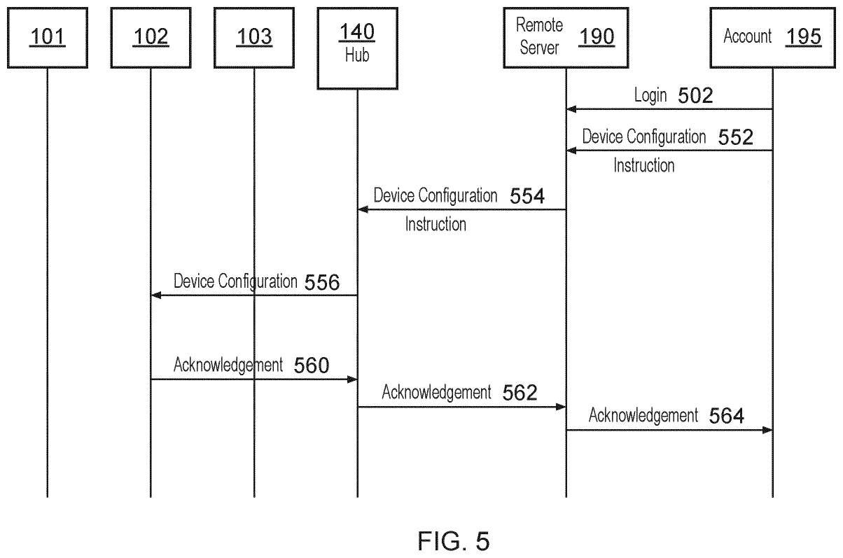

FIG. 5 is a signaling diagram showing a device configuration. A network manager logs in to their account 195 to access the platform provided by remote server 190. The network manager inputs a device configuration instruction 552 to remote server 190, the device configuration instruction specific to a particular device in the local network, in this case device 102. The remote server 190 then delivers 554 this device configuration instruction to the hub 140 associated with account 195. The hub 140 then performs 556 the device configuration on the nominated device 102. Device 102 returns an acknowledgement 560 to the hub 140. In response thereto, the hub 140 returns an acknowledgement 562 to the remote server 190. In response thereto, remote server 190 issues an acknowledgement 564 to the user account 195.

In general, the hub is set up in the local network either as an application running on a device already in the network or as a standalone device. The hub connects via an internet gateway connected to the local network through the internet to a remote server. The remote server may be a Web Application Server.

From the hub's perspective, on start up the hub contacts the remote server, establishes a secure connection using HTTPS, and uploads its hub key to check if that has been registered on the network management platform. If the hub key has not been registered, the hub will check every 5 minutes until the bub finds the hub key has been registered, at which point the hub is paired to an account on the network management platform.

Once the hub key is registered with the network management platform, and the hub is paired with an account, the hub retrieves hub settings from the remote server over an HTTPS connection. The hub polls the remote server for hub settings every 5 minutes in case those settings are changed. The hub settings include discovery instructions. The discovery instructions determine what information the hub will send out of the local network to the remote server. For example, a discovery instruction might be “only printers on port 631”.

After this, the hub will scan the network and use the discovery instructions to filter out anything that doesn't conform to the discovery instructions. The hub then sends the remaining device information to the server over HTTPS. This scanning, filtering, and reporting process is repeated every 30 seconds.

If the hub settings included the instruction to enable real-time communication, a separate thread is started that implements long-polling, i.e., an HTTPS request to the server. This HTTP request lasts for 10 seconds. If a command from the server is issued during these 10 seconds, the HTTP request returns immediately, and the hub executes the command on the local network. The results of the command are then posted immediately back to the server using HTTPS.

The hub establishes a secure communication connection to the remote server via HTTPS. HTTPS is a common communication protocol and so even where internet gateway 114 includes a firewall, the HTTPS communication from the hub to the remote server should be allowed by the firewall.

The remote server then sends discovery instructions to the Hub. Examples of discovery instruction are:
discover all devices;
discover only specific IP addresses;
discover devices running a specified port number/protocol;
discover devices by manufacturer (based on Organizationally Unique Identifier a.k.a. OUI, which is a 24-bit number of a MAC address); or
discover by MAC address.

The hub takes no action until it receives an instruction from the remote server. A local network manager sets up a user account on the remote server with a user device. Such an account may be configured via a web page served by the remote server to the user device. The local network manager configures hub discovery instructions using the user account. Further, the network manager inputs any hub keys for hubs connected to the local network into the remote server with the user account. When a hub connects to the remote server, the hub sends its unique hub key to the remote server. This allows the remote server to connect the hub to the user account and to send the hub discovery instructions selected by the network manager.

A benefit of this arrangement is that it allows the network manager to control what data is sent out from the local network to the remote server. Even if the hub is connected to the local network before the network manager has configured the hub to join the network manger's user account, the hub will not be sent discovery instructions by the remote server until the hub is connected to a user account.

The network manager may be referred to as the network owner or a local network manager. The network manager may or may not be the legal owner of the local network equipment, and may or may not be a network engineer. The network manager may be a local support representative.

A network management service may comprise the hub and an application running on the remote server. The network management service may be described as a platform. Access to the network management service is controlled by an account. An account may have at least one hub associated with it. Information from the local network is stored associated with an account. The account may comprise a master account, which is the one that originally creates the account, and one or more sub-accounts. Sub-accounts can be created to assign additional users access to the portal and the account. The master account has an administrator role. Sub-accounts may have a role that is either Administrator or Read-Only. The account may be associated with a plurality of hubs and/or local networks. Multiple hubs may be provided for a single local network to provide redundancy. Multiple types of hub may be provided for a single local network, for example at least one software hub and at least one a hardware hub may be installed on a single local network.

To allow installation of a new hub, the network management service will allow an Administrator account to create a new Network, then set the discovery instruction to either ‘Discover all devices’ or ‘Only discover specified devices’. The discovery instruction may be thought of as a Monitoring Mode. When set to ‘Discover all devices’, all data is returned to the remote server.

When set to ‘Only discover specified devices’ the hub—once paired to the appropriate account via hub key exchange—will then do nothing. The hub sits on the local network with an ‘Online’ status visible in the platform web portal. Only once the discovery instructions are defined are the monitoring criteria set allowing the hub to begin discovering anything within the local network.

Examples of criteria for defining the discovery instructions are: IP Address; MAC Address; OUI Identifier; TCP Port Active. The user may add multiple criteria to target very specific devices, i.e., only HP Printers—OUI (0001E6) and TCP Port Active (TCP/631). This data is processed by the Hub and only the filtered devices and information matching the defined criteria are sent over HTTPS to the remote server.

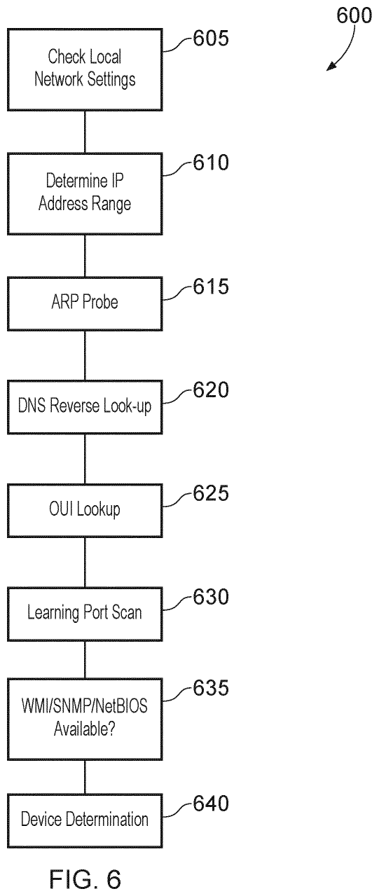

An example local network interrogation process 600 will now be described in connection with FIG. 6.

The hub is connected to the local network via an Ethernet connection. The first step of the network interrogation process is to check 605 the hub's local network settings using the Microsoft .Net Framework in a manner similar to the command ipconfig.

The resulting information includes data from Ethernet adapter including the local subnet information (IPv4 address). In this example the IPv4 information is:
IPv4 Address: 192.168.178.29
Subnet Mask: 255.255.255.0
Default Gateway: 192.168.178.1

From this information the hub can determine 610 the IP address range for devices connected to the local network. In this example the IP address range that the hub initially looks at is: 192.168.178.1 to 192.168.178.254. Knowing that the subnet mask is 255.255.255.0 (/24), the hub can determine that there are 256 available address on this subnet and therefore 254 hosts; *.0 and *.255 are broadcast addresses that cannot be assigned to a device.

The next step is for the hub to execute an ARP probe 615 via the Microsoft .Net Framework in the determined IP-address range. This will return a list of MAC addresses for each IP address that sends a reply. The ethernet standard mandates that a connected device must reply to an ARP probe 615. Accordingly, the hub obtains a MAC address for every device connected to the local network. The MAC address is a media access control address, and it is a unique identifier assigned to a network interface controller (NIC) of a device for that device to communicate at the data link layer of a network segment. MAC addresses are recognizable as six groups of two hexadecimal digits. A MAC address may be referred to as an Ethernet hardware address. MAC addresses are most often assigned by the manufacturer of a NIC and are stored in its hardware, such as the card's read-only memory or some other firmware mechanism. A MAC address may include the manufacturer's organizationally unique identifier (OUI). MAC addresses are formed according to the rules of one of three numbering name spaces managed by the Institute of Electrical and Electronics Engineers (IEEE). The result of the ARP probe 615 may look like this:

| | |
|---|---|
| 192.168.178.1 | 3431C4520B2A |
| 192.168.178.20 | 20C9D0111E43 |
| 192.168.178.22 | C82A14237755 |
| 192.168.178.24 | 0050608234BC |
| 192.168.178.25 | 2C44FDE4FDE0 |
| 192.168.178.26 | 5453EDF73283 |
| 192.168.178.29 | 281878FC6C72 |
| 192.168.178.33 | 001FF3F56AF6 |
| 192.168.178.38 | E4CE8F54C094 |
| 192.168.178.40 | 8CC8CD1630D4 |
| 192.168.178.59 | B8782E42AB44 |
| 192.168.178.61 | 18F643E38C9B |

The hub then performs a DNS reverse lookup 620 for each IP-address returned in the ARP-scan results. A reverse DNS lookup—commonly known as nslookup—is a method for querying the Domain Name System (DNS) to obtain domain name or IP address mapping or for any other specific DNS record. The result of the reverse DNS lookup may look like this:

| | | |
|---|---|---|
| 192.168.178.1 | 3431C4520B2A | fritz.box |
| 192.168.178.20 | 20C9D0111E43 | time-capsule.fritz.box |
| 192.168.178.22 | C82A14237755 | Tims-iMac.fritz.box |
| 192.168.178.24 | 0050608234BC | Tim-Kefford-1700MXP.fritz.box |
| 192.168.178.25 | 2C44FDE4FDE0 | HPE4FDE0.fritx.box |
| 192.168.178.26 | 5453EDF73283 | STR-DN1030 F73283.fritz.box |
| 192.168.178.29 | 281878FC6C72 | SURFACEPRO3.fritz.box |
| 192.168.178.33 | 001FF3F56AF6 | bedroom.fritz.box |
| 192.168.178.38 | E4CE8F54C094 | Tims-iMac.fritz.box |
| 192.168.178.40 | 8CC8CD1630D4 | **unknown** |
| 192.168.178.59 | B8782E42AB44 | Apple-TV.fritz.box |
| 192.168.178.61 | 18F643E38C9B | Tims-iPhone.fritz.box |

Note that 192.168.178.40 is unknown.

The hub then performs an OUI lookup 625. All MAC addresses are unique and the first 6 hexadecimal values are assigned to a manufacturer. This knowledge allows the hub to identify the device maker, and also to assist in pointing to the role of a device. For example, a MAC beginning 005060 refers to TANGBERG TELECOM AS, which allows the hub to infer that device's likely role is a video endpoint. In this example, the OUI Lookup for the above MAC addresses gives the following results.

| | | |
|---|---|---|
| 192.168.178.1 | 3431C4520B2A | AVM GmbH |
| 192.168.178.20 | 20C9D0111E43 | Apple |
| 192.168.178.22 | C82A14237755 | Apple |
| 192.168.178.24 | 0050608234BC | TANDBERG TELECOM AS |
| 192.168.178.25 | 2C44FDE4FDE0 | Hewlett Packard |
| 192.168.178.26 | 5453EDF73283 | Sony Corporation |
| 192.168.178.29 | 281878FC6C72 | Microsoft Corporation |
| 192.168.178.33 | 001FF3F56AF6 | Apple |
| 192.168.178.38 | E4CE8F54C094 | Apple |
| 192.168.178.40 | 8CC8CD1630D4 | Samsung Electronics Co., LTD |
| 192.168.178.59 | B8782E42AB44 | Apple |
| 192.168.178.61 | 18F643E38C9B | Apple |

These results tie in with some of the names. For example, the devices called iPhone® are made by Apple®. Usefully where the 192.168.178.40 address that didn't return any naming information, it has returned the manufacturer of the network card—Samsung. This allows the hub to flag this to the Network Manager to narrow down the identity of that device. In the present case it is a Samsung Television.

The hub then performs a learning port scan 630. The Learning Port Scan is used as it is more efficient than running longer port scans for device detection. Particular ports are much more likely to yield useful information when scanned. For example, if WMI (port 135) or SNMP (port 161) are discovered as open for a device, then the hub is able to scan those devices and quickly determine extended information about them.

WMI Classes of interest are:
Win32_ComputerSystem—System manufacturer/model info, RAM, domain, logged in user, 32 or 64 bit, serial number, time zone, DNS Name, etc. . . .
Win32_LogicalDisk—Drive letters, size and space, and File system type, and disk type (fixed, removeable, etc.)
Win32_DiskDrive—Make/model of disk, disk capabilities, USB or Fixed

For SNMP:
sysDescr—Full name and version identification of system's hardware type, software operating system and networking software
sysUpTime—Uptime measured since network management portion of the system was re-initialised
sysContact—Contact name (person) for device
sysName—System name
sysLocation—Physical location

In addition, the Learning Port Scan checks for NetBIOS ports being open (port 137). This not only allows the hub to identify the device name (when a reverse DNS lookup has failed) but also the Workgroup or Domain to which the device belongs. The NetBIOS ports scan is optimally done after the WMI and SNMP scan because this information will be gathered by those scans if they are successful, making the NetBIOS scan not necessary.

If WMI or SNMP ports are discovered as open on a device, then detailed device information is obtained by the hub using these interfaces. With SNMP, the hub tries with an SNMP Community string of “public”. NetBIOS provides details of the Computer Name and workgroup/domain that can be added to the Device information—this check can be done in addition to a successful NSLOOKUP command as the workgroup/domain information is additionally useful. To retrieve NetBIOS information from a device the hub runs an instruction in Microsoft .Net Framework similar to the nbtstat command.

The hub then performs device determination 640. With the above interrogation results, the hub is able to detect all devices on the local network and identify them to a high degree of accuracy. Indeed, using only the names of some devices is a clear way of determining their function, such as “Tims-iPhone” can be deduced as an iPhone, but additionally confirmed if the iPhone-sync service is detected running on that device.

Another example using a system with no identifier or role in the device name, bedroom.fritz.box, we can see that the manufacturer of the network card is Apple. Pair that with the fact that the airport-admin service is also running, the hub can make a good estimate this as an Apple AirPort device.

The hub makes its best guess as to the determination of the device. The network manager can manually identify unknown devices or correct mis-identified devices from an account user interface provided by the remote server. The device determination by the hub does not need to be 100% accurate to be useful. Identifying a handful of unusual devices on the local network is much easier for a network manager than trying to determine from the IP address the identity of every device. Further, if the hub is tasked with managing only HP® printers on the local network, the hub can reliably identify these and not report information on any other devices, thus preserving the security and/or confidentiality of the local network, while allowing remote access to the printers. The hub can reliably identify all HP® printers on the local network, without needing to establish the identity of every device on the local network. Put another way, if the hub is looking for HP® printers on the local network, it is sufficient to accurately identify that a device is not an HP® printer, without identifying it further.

Any of the above-described device determination steps performed by the hub may be performed with the assistance of the remote server. Such assistance is provided when the hub has discovery instructions such as “discover all devices”. For example, the hub can perform OUI lookup 625 without assistance from the remote server, but the remote server may be better able to identify a device from the available information than the hub alone. The network manager thus has the option to share information with the remote server to enable more accurate device determination. However, the hub is able to perform specific device determination reliably and without assistance from the server. For example, the hub is able to identify that a device is an HP® printer by virtue of the OUI in the device MAC address and that port TCP/631 is open for that device. This can be done without assistance from the remote sever.

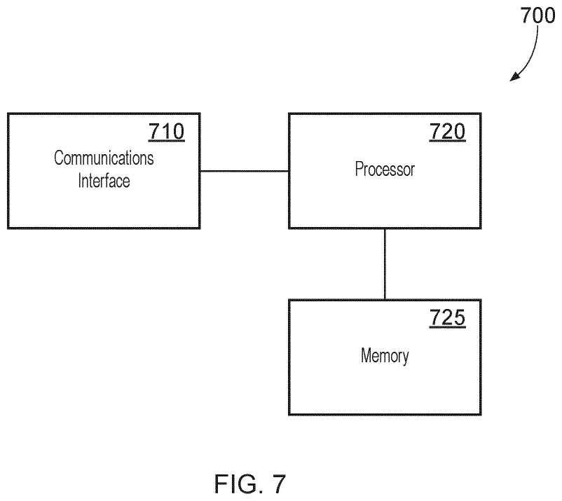

FIG. 7 illustrates a hub device 700 for remote network management, the hub device comprising a communication interface 710 and a processor 720. The communication interface 710 is arranged to communicate with a local network, the communication interface 710 also arranged to communicate with a remote server over a secure internet connection. The processor 720 is arranged to receive discovery instructions from the remote server, interrogate local devices connected to the local network, filter the interrogation results in accordance with the discovery instructions, and send the filtered results to the remote server.

The processor 720 may be arranged to receive instructions that, when executed, cause the processor 720 to carry out the above-described method. The instructions may be stored on a memory 725.

The filtering is performed within the local network such that only information defined by the discovery instructions leaves the local network. A user of the system may define the discovery instructions thus allowing that user to define what information about the local network leaves the local network. This makes it possible for the hub device 700 to be used for a specific purpose, such as managing printing devices, without the need to give access to other sensitive devices on the local network, such as local servers.

The processor 720 may be further arranged to receive a configuration command from the remote server, the configuration command for a local device connected to the local network, and perform a configuration operation on the local device.

The hub device 700 can identify devices on the local network according to the discovery instructions. Once the devices are identified, the hub device 700 can deliver configuration commands to a device on the local network. The configuration command may be delivered via a telnet interface or a browser interface.

The secure internet connection may use the HTTPS protocol.

The interrogation may use network fingerprinting. The interrogation may use at least one of local network address range, Address Resolution Protocol (ARP), reverse DNS queries, OUI Lookup, Port scan, or detection of NetBIOS, WMI, and SNMP.

The discovery instructions may define a type of device that is to be reported to the remote server.

The hub device 700 may comprise a local device connected to the local network that is adapted to operate as a hub device 700. The adaptation may comprise installing a software application on the local device. The local device may be a personal computer, a server, or some other multi-function computing device. The hub device 700 may be built into a local device such as a network connected printer. The hub device functionality may be installed on an existing local device such as a network connected printer by way of a firmware upgrade.

The hub device 700 may be a dedicated device connected to the local network. The dedicated device may be a Raspberry Pi® or similar inexpensive computing device.

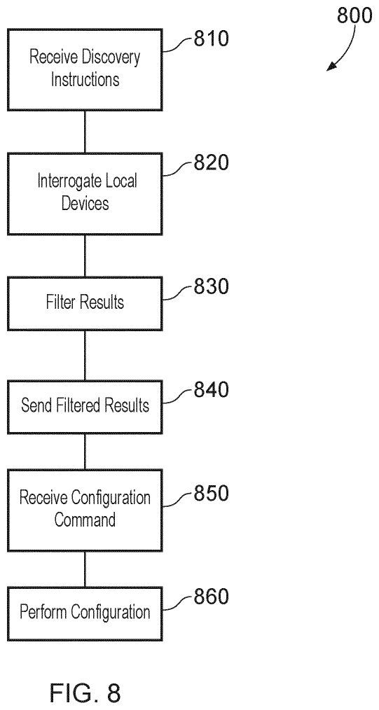

FIG. 8 illustrates a method 800 for remote network management, the method 800 performed by a device arranged to communicate with a local network and to communicate with a remote server over a secure internet connection. The method comprises receiving 810 discovery instructions from the remote server, interrogating 820 local devices connected to the local network, filtering 830 the interrogation results in accordance with the discovery instructions, and sending 840 the filtered results to the remote server.

The device could be an existing local device upon which hub software is installed to perform the above defined method. The device could be a dedicated hub device connected to the local network to perform the above defined method.

The method 800 may further comprise receiving 850 a configuration command from the remote server, the configuration command for a local device connected to the local network, and performing 860 a configuration operation on the local device.

There is further provided a computer-readable medium carrying instructions that, when executed by a processor of a local device connected to a local network via a communication interface, causes said processor to: receive discovery instructions from a remote server via the communication interface of the local device, interrogate local devices connected to the local network, filter the interrogation results in accordance with the discovery instructions, and send the filtered results to the remote server.

The computer-readable medium may carry further instructions for causing said processor to receive a configuration command from the remote server, the configuration command for a local device connected to the local network, and perform a configuration operation on the local device.

There is further provided an apparatus for remote network management comprising a processor and a memory. Said memory contains instructions executable by said processor whereby said apparatus is operative to receive discovery instructions from a remote server, interrogate local devices connected to a local network, filter the interrogation results in accordance with the discovery instructions, and send the filtered results to the remote server.

There is further provided an apparatus for remote network management comprising a processor and a memory. Said memory contains instructions executable by said processor whereby said apparatus comprises means for receiving discovery instructions from a remote server, means for interrogating local devices connected to a local network, means for filtering the interrogation results in accordance with the discovery network, and means for sending the filtered results to the remote server.

There is further provided a computer-readable medium carrying instructions that, when executed by computer logic, causes said computer logic to carry out any of the methods defined herein.

There is further provided a computer-readable storage medium storing instructions that, when executed by computer logic, causes said computer logic to carry out any of the methods defined herein. The computer program product may be in the form of a non-volatile memory or volatile memory, e.g., an EEPROM (Electrically Erasable Programmable Read-only Memory), a flash memory, a disk drive, or a RAM (Random-access memory).

There is further provided an application for remote network management, the application arranged to be run on a device comprising a communication interface for communicating with a local network. the communication interface also for communicating with a remote server over a secure internet connection. The application is arranged to receive discovery instructions from a remote server via the communication interface of the local device, interrogate local devices connected to the local network, filter the interrogation results in accordance with the discovery instructions, and send the filtered results to the remote server.

There is further provided a computer-readable medium carrying instructions that, when executed by computer logic, causes said computer logic to carry out any of the methods defined herein.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on an order in which actions are to be performed.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope

The user device may be a user apparatus. The user device may be any kind of personal computer such as a television, a smart television, a set-top box, a games-console, a home-theatre personal computer, a tablet, a smartphone, a laptop, or even a desktop PC.

The remote server may be a physical sever device connected to the internet at a location separate from the local network. The remote server may be a virtual server. The remote server may be part of a cloud computing environment. The service platform may be hosted in a cloud computing environment.

Further, while examples have been given in the context of a particular communications network, these examples are not intended to be the limit of the communications networks to which the disclosed method and apparatus may be applied. The principles disclosed herein can be applied to any communications network that allows devices to communicate, including both wired IP networks and wireless communications networks.

1. A hub device for remote network management, the hub device comprising a communication interface for communicating with a local network, the communication interface also for communicating with a remote server over a secure internet connection, the hub device further comprising a processor arranged to:
receive discovery instructions from the remote server;
interrogate local devices connected to the local network;
filter the interrogation results in accordance with the discovery instructions; and
send the filtered results to the remote server.

2. The hub device of claim 1, wherein the processor is further arranged to:
receive a configuration command from the remote server, the configuration command for a local device connected to the local network; and
perform a configuration operation on the local device.

3. The hub device of claim 1, wherein the secure internet connection uses the HTTPS protocol.

4. The hub device of claim 1, wherein the interrogation uses network fingerprinting.

5. The hub device of claim 1, wherein the interrogation uses at least one of:
Local network address range,
Address Resolution Protocol,
Reverse DNS queries,
OUI Lookup,
Port scan, or
NetBIOS, WMI, and SNMP detection.

6. The hub device of claim 1, wherein the discovery instructions define a type of device that is to be reported to the remote server.

7. The hub device of claim 1, wherein the hub device comprises a local device connected to the local network that is adapted to operate as a hub device.

8. The hub device of claim 1, wherein the hub device is a dedicated device connected to the local network.

9. A method for remote network management, the method performed by a device arranged to communicate with a local network and to communicate with a remote server over a secure internet connection, the method comprising:
receiving discovery instructions from the remote server;
interrogating local devices connected to the local network;
filtering the interrogation results in accordance with the discovery instructions; and
sending the filtered results to the remote server.

10. The method of claim 9 further comprising:
receiving a configuration command from the remote server, the configuration command for a local device connected to the local network; and
performing a configuration operation on the local device.

11. The method of claim 9, wherein the secure internet connection uses the HTTPS protocol.

12. The method of claim 9, wherein the interrogation uses network fingerprinting.

13. The method of claim 9, wherein the interrogation uses at least one of:
Local network address range,
Address Resolution Protocol (ARP),
Reverse DNS queries,
OUI Lookup,
Port scan, or
NetBIOS, WMI, and SNMP detection.

14. The method of claim 9, wherein the discovery instructions define a type of local device that is to be reported to the remote server.

15. (canceled)

16. (canceled)

17. An apparatus for remote network management comprising a processor and a memory, said memory containing instructions executable by said processor whereby said apparatus is operative to:
receive discovery instructions from a remote server;
interrogate local devices connected to a local network;
filter the interrogation results in accordance with the discovery instructions; and
send the filtered results to the remote server.

18. (canceled)

19. A computer-readable medium, carrying instructions, which, when executed by computer logic, causes said computer logic to carry out the method defined by claim 9. to 15.

20. The hub device of claim 2, wherein the secure internet connection uses the HTTPS protocol.

21. The hub device of claim 2, wherein the interrogation uses network fingerprinting.

22. The hub device of claim 2, wherein the interrogation uses at least one of:
Local network address range,
Address Resolution Protocol,
Reverse DNS queries,
OUI Lookup,
Port scan, or
NetBIOS, WMI, and SNMP detection.

23. The hub device of claim 2, wherein the discovery instructions define a type of device that is to be reported to the remote server.
